(19) United States
(12) Patent Application Publication
(10) Pub. No.: US 2012/0167170 A1
(43) Pub. Date: Jun. 28, 2012

(54) METHOD AND APPARATUS FOR PROVIDING PASSIVE USER IDENTIFICATION

(75) Inventors: Weidong Shi, Windsor (CA); Jun Yang, Milpitas, CA (US); Feng Yang, Stanford, CA (US); Yingen Xiong, Mountain View, CA (US)

(73) Assignee: Nokia Corporation

(21) Appl. No.: 12/979,698

(22) Filed: Dec. 28, 2010

(51) Int. Cl. G06F 7/04

(52) U.S. Cl. 726/2

(57) ABSTRACT

A method for providing passive user identification may include causing selective processing of data indicative of characteristics of a user of a device by aggregating one or more modality specific biometric classification processes conducted in background operation of the device, comparing the selectively processed data to a profile of a currently logged in or default user to determine a likelihood that the user corresponds to the currently logged in or default user, and selectively implementing an active authentication process based on a result of the determining. A corresponding apparatus and computer program product are also provided.

### TECHNOLOGICAL FIELD

Some example embodiments of the present invention relate generally to device security technology and, more particularly, relate to a method and apparatus for providing a mechanism by which passive user identification may be securely and efficiently accomplished.

### BACKGROUND

Communication devices are becoming increasingly ubiquitous in the modern world. In particular, mobile communication devices seem to be popular with people of all ages, socio-economic backgrounds and sophistication levels. Accordingly, users of such devices are becoming increasingly attached to their respective mobile communication devices. Whether such devices are used for calling, emailing, sharing or consuming media content, gaming, navigation or various other activities, people are more connected to their devices and consequently more connected to each other and to the world at large.

Due to advances in processing power, memory management, application development, power management and other areas, communication devices, such as computers, mobile telephones, cameras, multimedia internet devices (MIDs), personal digital assistants (PDAs), media players and many others are becoming more capable. Moreover, the popularity and utility of mobile communication devices has not only fueled the usage of such devices for personal reasons, but many businesses and employers are also providing such devices for their employees. Thus, many devices may be used for both personal and professional tasks. In some cases, the professional tasks may be associated with handling sensitive information or with providing access to proprietary information. As such, security of such devices may become an issue of concern.

One of the key factors impacting the preferences of users (and hence the sales and usage of such devices) is the user experience. If users are enabled to interact with their device in a relatively seamless manner, the users generally enjoy the experience more and tend to use the device more frequently and develop loyalty to the device and perhaps also the brand associated with the device. However, if interaction with the device is cumbersome, users tend to find another device or at least limit their interaction with the device to only needed tasks.

Many security-related provisions that may be implemented on electronic devices involve the interruption of functionality until the user provides proper authentication. However, this type of interruption is generally disruptive to the user experience and may become extremely cumbersome if it is required every time a mobile electronic device wakes from a battery preservation induced sleep period.

Some thought has been given to ways to provide user identification in a more passive, and therefore less intrusive manner. For example, implicit user identification may be provided in some cases. However, typical implicit user identification solutions tend to consume large amounts of power and can simply be turned off by an individual that steals the corresponding mobile device. Thus, it may be desirable to develop alternative mechanisms by which to provide device security in a relatively efficient manner.

### BRIEF SUMMARY

A method, apparatus and computer program product are provided to enable passive user identification that may be securely and efficiently accomplished. In some cases, the passive user identification may be provided in a manner that enables efficient power management, utilizes multiple sensing modalities, and/or is a protected service that runs in a secure or privileged domain.

In one example embodiment, a method of providing passive user identification is provided. The method may include causing selective processing of data indicative of characteristics of a user of a device by aggregating one or more modality specific biometric classification processes conducted in background operation of the device, comparing the selectively processed data to a profile of a currently logged in or default user to determine a likelihood that the user corresponds to the currently logged in or default user, and selectively implementing an active authentication process based on a result of the determining.

In another example embodiment, an apparatus for providing passive user identification is provided. The apparatus may include at least one processor and at least one memory including computer program code. The at least one memory and the computer program code may be configured to, with the at least one processor, cause the apparatus to perform at least causing selective processing of data indicative of characteristics of a user of a device by aggregating one or more modality specific biometric classification processes conducted in background operation of the device, comparing the selectively processed data to a profile of a currently logged in or default user to determine a likelihood that the user corresponds to the currently logged in or default user, and selectively implementing an active authentication process based on a result of the determining.

In one example embodiment, another apparatus for providing passive user identification is provided. The apparatus may include means for causing selective processing of data indicative of characteristics of a user of a device by aggregating one or more modality specific biometric classification processes conducted in background operation of the device, means for comparing the selectively processed data to a profile of a currently logged in or default user to determine a likelihood that the user corresponds to the currently logged in or default user, and means for selectively implementing an active authentication process based on a result of the determining.

In another example embodiment, a computer program product for providing passive user identification is provided. The computer program product may include at least one computer-readable storage medium having computer-executable program code instructions stored therein. The computer-executable program code instructions may include program code instructions for causing selective processing of data indicative of characteristics of a user of a device by aggregating one or more modality specific biometric classification processes conducted in background operation of the device, comparing the selectively processed data to a profile of a currently logged in or default user to determine a likelihood that the user corresponds to the currently logged in or default user, and selectively implementing an active authentication process based on a result of the determining.

Some embodiments of the invention may provide a method, apparatus and computer program product for improving user experience relating to devices having passive user identification. As a result, for example, mobile terminal users may enjoy improved security with respect to their devices, but may also substantially avoid intrusive security related operations.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an example embodiment of the present invention;

FIG. 2 is a schematic block diagram of an apparatus for providing passive user identification according to an example embodiment of the present invention;

FIG. 3 illustrates a block diagram of example channels via which sensor information may be provided to a user identification engine according to an example embodiment of the present invention;

FIG. 4 illustrates a flow diagram showing a process of passive user identification according to an example embodiment of the present invention;

FIG. 5 illustrates a flow diagram showing a process of invoking active authentication when a current user tries to access private or personal data or tries to access credentials that are stored in a mobile terminal and are associated with the default profile or the current login profile according to an example embodiment of the present invention; and

FIG. 6 is a block diagram according to an example method for providing passive user identification according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with some embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

Some embodiments of the present invention may relate to the provision of passive user identification of the user of a user terminal (e.g., a mobile terminal). In some example embodiments, provision is made for implicit or passive user identification using any or all of a plurality of different sensing devices. Moreover, in some cases, the sensing devices used may be relatively low cost additions to the user terminal or generally already included in most user terminals so that cost of implementation is relatively low. In an example embodiment, power consumption may be balanced against sensor employment to manage the number of different sensors employed or to strategically select the sensors to be employed in consideration of available power relative to the expected power consumption and accuracy of each respective different sensor. In some embodiments, the implementation of passive user identification may be provided by a privileged and/or protected service running in a privileged domain.

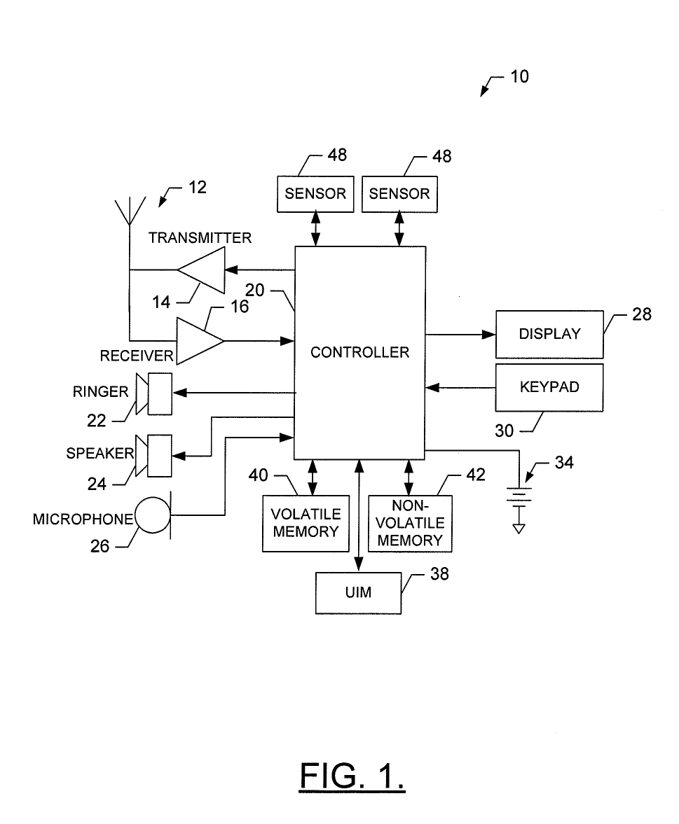

FIG. 1, one example embodiment of the invention, illustrates a block diagram of a mobile terminal 10 that would benefit from embodiments of the present invention. It should be understood, however, that the mobile terminal 10 as illustrated and hereinafter described is merely illustrative of one type of device that may benefit from embodiments of the present invention and, therefore, should not be taken to limit the scope of embodiments of the present invention. As such, although numerous types of mobile terminals, such as portable digital assistants (PDAs), multimedia internet devices (MIDs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments.

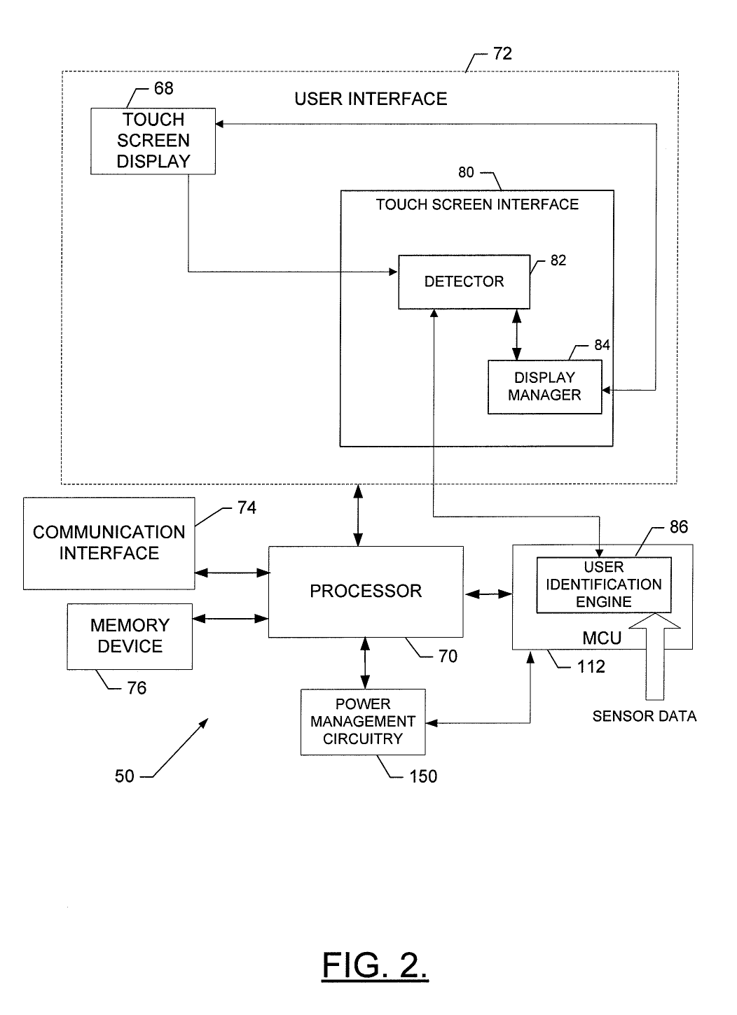

The mobile terminal 10 may include an antenna 12 (or multiple antennas) in operable communication with a transmitter 14 and a receiver 16. The mobile terminal 10 may further include an apparatus, such as a controller 20 or other processing device (e.g., processor 70 of FIG. 2), which controls the provision of signals to and the receipt of signals from the transmitter 14 and receiver 16, respectively. The signals may include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 may be capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols (e.g., Long Term Evolution (LTE) or LTE-Advanced (LTE-A) or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

In some embodiments, the controller 20 may include circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 may additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (display 28 providing an example of such a touch display) or other input device. In embodiments including the keypad 30, the keypad 30 may include the conventional numeric (0-9) and related keys (#, *), and other hard and soft keys used for operating the mobile terminal 10. Alternatively or additionally, the keypad 30 may include a conventional QWERTY keypad arrangement. The keypad 30 may also include various soft keys with associated functions. In addition, or alternatively, the mobile terminal 10 may include an interface device such as a joystick or other user input interface. Some embodiments employing a touch display may omit the keypad 30 and any or all of the speaker 24, ringer 22, and microphone 26 entirely. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10.

In some embodiments, the mobile terminal 10 may also include one or more sensors 48 of various types. In an example embodiment, one or more of the sensors 48 may include a camera or other media capturing element in order to capture images or video of objects, people and places proximate to the user of the mobile terminal 10. In some cases, one or more of the sensors 48 may be a positioning or movement sensor. As such, the sensor 48 may include, for example, an accelerometer, an inertial sensor, or other device capable of determining movement of the mobile terminal 10 relative to some reference. In some cases, the sensor 48 may include Micro-electro-mechanical Systems (MEMS) components and/or piezoelectric, piezoresistive, capacitive or other hardware components that may be used to convert mechanical motion into an electrical signal for sensing motion of the mobile terminal 10 and providing electrical signals responsive to, proportional to or otherwise based on the motion of the mobile terminal 10 (or more specifically the motion of the sensor 48). As used herein, movement of the sensor 48 may refer to acceleration of the sensor 48 (or the apparatus in/on which the sensor 48 is located or housed), angular speed, latitude and longitude coordinates, cell identification, distance from a reference point, and/or proximity information. The movement of the sensor 48 may therefore be measured, for example, by a MEMS type structure for acceleration, by a gyroscope for angular speed, or by a proximity sensor for proximity information. Step rate, motion states and other movement related data may then be analyzed relative to the habits or characteristics of a particular user.

In an example embodiment, one or more of the sensors 48 may be embodied as an ear sensor configured to determine the structure of the interior of the ear of an individual using the mobile terminal 10 based on the propagation of sound in the ear. Alternatively or additionally, the sensor 48 may be embodied as a thermopile array. A thermopile array may be implemented using various different array configurations (e.g., 10×10, 8×8, 4×8, 16×8, etc.) of thermopile sensors. A thermopile sensor may be an example of an electronic device that converts thermal energy into electrical energy by generating an output voltage that is proportional to a local temperature difference or temperature gradient. The thermopile array may be able, in some cases, to perform eye detection and measure the distance between eyes of a user looking at the display of the mobile terminal 10. Other examples of devices that may be implemented as sensors 48 may include touch screen sensors (e.g., to measure touch pressure, touch area, touch distances when multiple fingers are employed, touch duration, touch interval, touch keyboard dynamics, and/or the like) to determine gesture anomalies or other user dependent features that may be evident by analyzing raw touch input data. In some embodiments, a microphone may also be used to detect voice input and determine user identity based on the voice input.

An example embodiment of the invention will now be described with reference to FIG. 2, in which certain elements of an apparatus 50 for providing a mechanism by which passive user identification may be accomplished are displayed. The apparatus 50 of FIG. 2 may be employed, for example, in conjunction with the mobile terminal 10 of FIG. 1. However, it should be noted that the apparatus 50 of FIG. 2, may also be employed in connection with a variety of other devices, both mobile and fixed, and therefore, embodiments of the present invention should not be limited to application on devices such as the mobile terminal 10 of FIG. 1. For example, the apparatus 50 may be employed on a personal computer or other user terminal. Moreover, in some cases, the apparatus 50 may be on a fixed device such as server or other service platform and the content may be presented (e.g., via a server/client relationship) on a remote device such as a user terminal (e.g., the mobile terminal 10) based on processing that occurs at the fixed device.

It should also be noted that while FIG. 2 illustrates one example of a configuration of an apparatus for providing a mechanism by which passive user identification may be accomplished, numerous other configurations may also be used to implement embodiments of the present invention. As such, in some embodiments, although devices or elements are shown as being in communication with each other, hereinafter such devices or elements should be considered to be capable of being embodied within a same device or element and thus, devices or elements shown in communication should be understood to alternatively be portions of the same device or element.

Referring now to FIG. 2, the apparatus 50 for providing a mechanism by which relevant content may be determined and/or presented is provided and may include or otherwise be in communication with a processor 70, a user interface 72, a communication interface 74 and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, applications, instructions or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 50 may, in some embodiments, be a mobile terminal (e.g., mobile terminal 10) or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen(s), touch areas, soft keys, a microphone, a speaker, or other input/output mechanisms. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the apparatus 50 may include or otherwise be in communication with a touch screen display 68 (e.g., the display 28). In different example cases, the touch screen display 68. The touch screen display 68 may be embodied as any known touch screen display. Thus, for example, the touch screen display 68 could be configured to enable touch recognition by any suitable technique, such as resistive, capacitive, infrared, strain gauge, surface wave, optical imaging, dispersive signal technology, acoustic pulse recognition, etc. techniques. The user interface 72 may be in communication with the touch screen display 68 to receive indications of user inputs at the touch screen display 68 and to modify a response to such indications based on corresponding user actions that may be inferred or otherwise determined responsive to the indications.

In an example embodiment, the apparatus 50 may include a touch screen interface 80. The touch screen interface 80 may, in some instances, be a portion of the user interface 72. However, in some alternative embodiments, the touch screen interface 80 may be embodied as the processor 70 or may be a separate entity controlled by the processor 70. As such, in some embodiments, the processor 70 may be said to cause, direct or control the execution or occurrence of the various functions attributed to the touch screen interface 80 (and any components of the touch screen interface 80) as described herein. The touch screen interface 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the touch screen interface 80 as described herein. Thus, in examples in which software is employed, a device or circuitry (e.g., the processor 70 in one example) executing the software forms the structure associated with such means.

The touch screen interface 80 may be configured to receive an indication of an input in the form of a touch event at the touch screen display 68. As such, the touch screen interface 80 may be in communication with the touch screen display 68 to receive indications of user inputs at the touch screen display 68 and to modify a response to such indications based on corresponding user actions that may be inferred or otherwise determined responsive to the indications. Following recognition of a touch event, the touch screen interface 80 may be configured to determine a classification of the touch event and provide a corresponding function based on the touch event in some situations.

In some embodiments, the touch screen interface 80 may include a detector 82, and a display manager 84. Each of the detector 82 and the display manager 84 may be any device or means embodied in either hardware or a combination of hardware and software configured to perform the corresponding functions associated with the detector 82 and the display manager 84, respectively, as described herein. In an exemplary embodiment, each of the detector 82 and the display manager 84 may be controlled by or otherwise embodied as the processor 70.

The detector 82 may be in communication with the touch screen display 68 to receive indications of user inputs in order to recognize and/or determine a touch event based on each input received at the detector 82. A touch event may be defined as a detection of an object, such as a stylus, finger, pen, pencil or any other pointing device, coming into contact with a portion of the touch screen display in a manner sufficient to register as a touch. In this regard, for example, a touch event could be a detection of pressure on the screen of the touch screen display 68 above a particular pressure threshold over a given area or the detection of a change in the electrostatic field of the touch screen display 68 at a particular location. As such, some touch events may not actually require physical contact with the touch screen display 68. For example, in some cases, the touch screen display 68 may be configured to detect one or more objects (e.g., a finger or fingers) hovering over the touch screen display 68. Gestures associated with the object or objects may also be detected in some cases, even without physical contact with the touch screen display 68. Subsequent to each touch event, the detector 82 may be further configured to recognize and/or determine a corresponding classification of the event. In other words, the detector 82 may be configured to classify the touch event as any of a number of possible gestures.

In an example embodiment, the detector 82 may be configured to communicate detection information regarding the recognition, detection and/or classification of a touch event to the display manager 84. The display manager 84 may be configured to provide control over modifications made to that which is displayed on the touch screen display 68 based on the detection information received from the detector 82.

The detector 82 may also provide input regarding touch events to a user identification engine 86. The user identification engine 86 may be any means such as a device or circuitry operating in accordance with software or otherwise embodied in hardware or a combination of hardware and software (e.g., processor 70 or MCU 112 operating under software control, the processor 70 embodied as an ASIC or FPGA specifically configured to perform the operations described herein, or a combination thereof) thereby configuring the device or circuitry to perform the corresponding functions of the user identification engine 86 as described herein. Thus, in examples in which software is employed, a device or circuitry (e.g., the processor 70 or MCU 112 in one example) executing the software forms the structure associated with such means. As such, in some embodiments, the processor 70 or MCU 112 may embody the user identification engine 86 and may be said to cause the corresponding functions of the user identification engine 86 that are to be performed.

In an example embodiment, the user identification engine 86 may be configured to repeatedly or continuously scan or otherwise receive indications of conditions, activities or data gathered by the various sensors (e.g., sensors 48 of FIG. 1) and/or the detector 82. The user identification engine 86 may then use the indications received thereat to initially build a profile of the registered user of the mobile terminal 10. Thus, for example, if multiple users may be associated with the mobile terminal 10, the user identification engine 86 may be configured to generate a profile for each respective user. If there is a default login user, then that user will be assumed to be the current user unless another login is used. To build the profile, the user identification engine 86 may therefore control the analysis of biometric data and/or other information that may be passively gathered during user operation of the mobile terminal 10 in order to determine the habits or characteristics of the user based on the data received.

Once a profile is established, the user identification engine 86 may be further configured to compare the indications currently being received (e.g., from sensors) to the profile to determine whether the current user is likely to be (e.g., is statistically similar in behavior or characteristics) the user associated with the profile. In some cases, the user identification engine 86 may employ a scoring algorithm to provide a score for each respective characteristic measured based on the indications and data received. The data currently gathered (e.g., current scores) may therefore serve to confirm the identity of the current user as a registered user (e.g., if the current indications (scores) match the profile within a threshold or predetermined amount) or to make a determination that the current user is not the registered user (e.g., if the current indications (scores) do not match the profile within the threshold or predetermined amount.

In an example embodiment, operation of the mobile terminal 10 may be permitted for either the currently logged in user or for the default login user unless or until the user identification engine 86 determines that the indications received for the current user do not match the corresponding profile for the assumed current user. In some embodiments, if the user identification engine 86 determines that the indications received for the current user do not match the corresponding profile for the assumed current user, the user identification engine 86 may trigger a security response. The security response may include locking the user interface of the mobile terminal 10 or restricting access to certain (perhaps sensitive or privileged) information, applications, or functionalities of the mobile terminal 10. In some cases, the current user may be prompted to provide a security code, password or otherwise complete a full login in order to verify that the current user is associated with a valid profile event though, for whatever reason, the behavior or characteristics exhibited by the current user may not have matched (within an acceptable range of scores) that of the user's profile. If the user authenticates himself or herself, full operation and/or access may be restored.

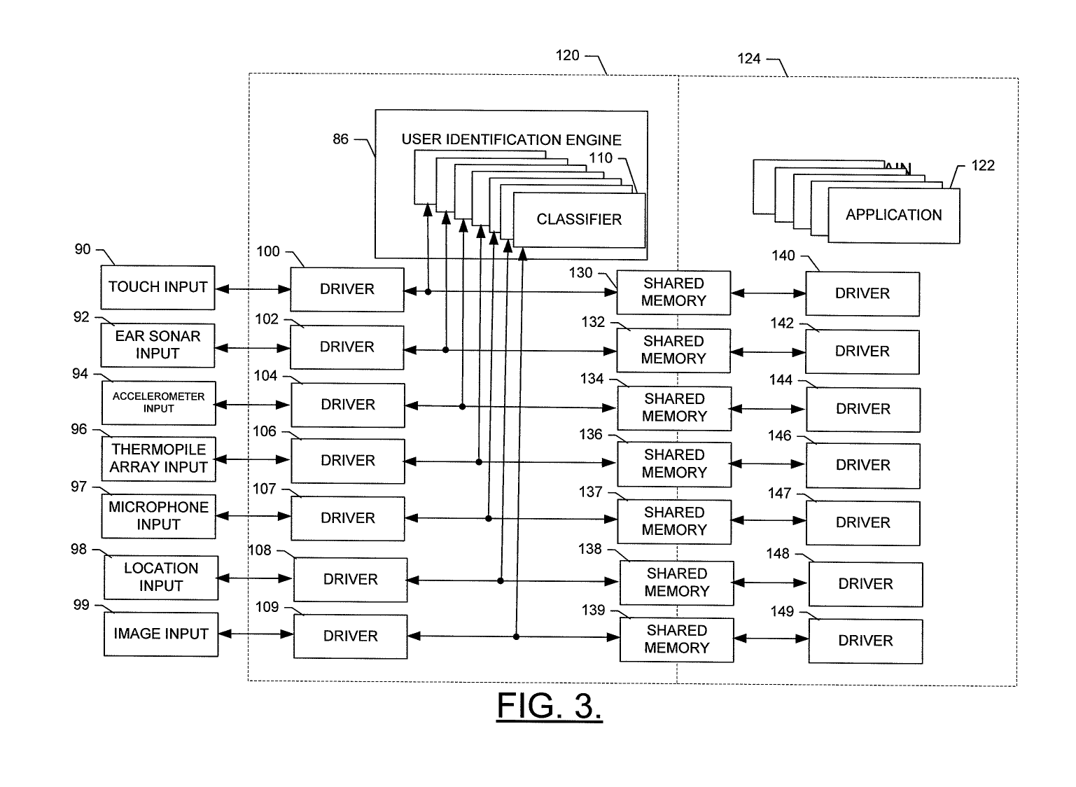

In an example embodiment, the user identification engine 86 may receive sensor information or other data that can be used for passive user identification via a plurality of respective different channels. FIG. 3 illustrates a block diagram of example channels via which sensor information may be provided to the user identification engine 86. However, it should be understood that various other sensors could be used in addition to or instead of those that are shown in FIG. 3.

Referring now to FIG. 3, the user identification engine 86 may passively receive touch input 90, ear sonar input 92, accelerometer input 94 (or any other location-related input), thermopile array input 96, microphone input 97, location input 98, image input 99 and/or the like. Each of these inputs may correspond to a respective different modality and may be passed through a corresponding driver (e.g., drivers 100, 102, 104, 106, 107, 108 and 109, respectively) before being passed on to the user identification engine 86. The user identification engine 86 may employ one or more modality specific biometric classifiers (e.g., classifier 110) that may each be configured to perform biometric classification to identify a user implicitly using inputs from multiple sensing devices that are integrated with the computing system. Thus, for example, by aggregating classification results from multiple sensing channels, the user identification engine 86 may enhance its accuracy and utility. Moreover, the user identification engine 86 may operate in the background and not interfere with other active applications.

In an example embodiment, each biometric classifier may be a one-to-many binary classifier that determines activity differences between current and reference data. In an example embodiment, the processor 70 (or in some cases a microprocessor (e.g., MCU 112)) may combine results from different classifiers to generate an aggregated score or aggregated measurement that may be used to determine whether the current user is an authorized user. The aggregated score or measurement may represent (e.g., based on its proximity to scores or measurements associated with a certain profile) a determination as to the likelihood of the current user being the user associated with a corresponding profile (e.g., the current user versus the logged in user). In some cases, the aggregation may be performed by designing a second-level classifier using outputs from each biometric classifier to aggregate, over a time window, the data received. As such, in some embodiments, space-time aggregation may be accomplished to take space and time properties into account as properties for consideration with respect to passive user identification.

In an exemplary embodiment, the user identification engine 86 (or the processor 70 or MCU 112) may be configured to handle inputs from all, or a subset, of the sensors that are capable of providing an input thereto and aggregate the inputs received. Thus, for example, if all sensors provide an input, the user identification engine 86 may be configured to generate a robust passive user identification result since all possible data may be considered to make a comparison of current user characteristics to a profile. However, if (for whatever reason) less than all of the sensors are used to provide an input, the user identification engine 86 may aggregate only the data provided to generate a slightly less robust passive user identification result since less than all possible data may be considered to make a comparison of current user characteristics to a profile. In some embodiments, to design a classifier with a dynamic feature set, Bayesian fusion methods may be used under the condition that the outputs of the classifiers are expressed in posterior probabilities. Accordingly, example embodiments may employ a space-time classifier aggregation that does not assume a fixed dimension. Another important feature of the space-time classifier aggregation that may be performed by example embodiments is that aggregated sequential classification may be accomplished by correlating outputs from multiple classifiers over time. By combining mobile biometric/behavior data from multiple sensing devices over a time window, the aggregation can capture the temporal correlation of a sequence of sensor inputs and deliver results with higher accuracy.

In some embodiments, a multi-domain environment may be employed. Each domain may be a runtime system that comprises an operating system, software applications, processes, user data and resources. The multiple domains may be provided via virtualization in some cases and may include a host domain and a set of guest domains. The host domain may be considered to be a privileged domain that may control and/or manage other domains. In a virtualization-based multi-domain system, a hypervisor may manage the allocation of resources to guest domains and may restrict access to resource of one domain by another domain. The host domain may include hardware support and software/firmware that is used to support control processing elements or input/output virtualization by intervening on one or more of, for example, memory management, configuration, input/output operations, memory operations from a domain, and completion and interruption operations to a domain. A guest domain may include a general or special purpose operating system. Users may often be enabled to interact directly with guest domains and have full control of operations within the guest domains. However, the host domain is typically a protected/privileged domain that requires privilege escalation for access.

In an example embodiment, the user identification engine 86 may be isolated within a multi-domain system in order to prevent inappropriate access to the user identification engine 86 such as efforts to stop operation of the user identification engine 86. As an example, the user identification engine 86 may be isolated into a privileged or secure domain (e.g., host domain 120), while other applications 122 may operate within one or more other domains (e.g., guest domain 124). In some cases, data from the sensors that are employed by the host domain 120 to perform multi-modal passive user identification may also be used by the guest domain 124 via corresponding drivers (e.g. drivers 130, 132, 134, 136, 137, 138 and 139, respectively) and in some cases also using shared memory (e.g., memories 140, 142, 144, 146, 147, 148 and 149, respectively). A hypervisor or other entity may manage operation with respect to components of the various different domains of the multi-domain system. Thus, by employing the user identification engine 86 within a protected or privileged domain, greater security may be provided since operation of the user identification engine 86 may not be stopped inappropriately.

By employing the protected domain 120, the passive user identification operations that are operated in the background by the user identification engine 86 may not be stopped by a suspicious person simply terminating operation of the user identification engine 86 since the suspicious person will be denied access to the protected domain 120. Thus, passive user identification may essentially be provided as a privileged and protected service running in a privileged and protected domain of a multi-domain system.

As indicated above, some embodiments may employ the MCU 112 as a sensing processor. The MCU 112 may be a lower power processor and thus, the user identification engine 86 may run in the background without impacting other applications, while also consuming less power. In some cases, the MCU 112 may be powered from a separate power supply from that which powers processor 70 so that the MCU 112 can be power managed independently and continue to power operation of the user identification engine 86 even when the main functionality of the mobile terminal 10 is powered off. As such, some example embodiments may employ power supply decoupling. By using the MCU 112, connection may be made (e.g., via communication busses) to the various sensors in order to integrate management of those sensors under a separately power managed processor. As such, some embodiments may employ power management circuitry 150 (see FIG. 2) to manage power of the MCU 112 separately from power management of the processor 70 and/or other mobile terminal 10 components. Thus, the mobile terminal 10 may be in a sleep mode, but the MCU 112 may still receive and process inputs from various ones of the sensors. Thus, certain functions (e.g., those associated with passive user identification and perhaps some other critical functions as well) may be performed by the MCU 112 even when the main processor 70 is not fully operational or is powered off. As an example, if the MCU 112 connects to a GSM modem, GPS or other location input 98, connects to an alarm clock, and/or connects to the image input 99 (e.g., from a front-camera), certain functionality such as monitoring specific sensors may be handled by the MCU 112 while the processor 70 is powered off and the processor 70 may be powered back on when certain (e.g., predefined) conditions are met.

Accordingly, some example embodiments may employ multi-modality sensor management to opportunistically use available sensors for implicit or passive user identification (or verification) while achieving balance between power efficiency and accuracy. In some cases, the sensors that are used (and therefore powered) may be selectively employed based on balancing considerations regarding power consumption and accuracy. For example, if battery power is low, only low power and/or passive sensors may be employed. However, if there is a relatively large amount of battery power available, more sensors (including those that consume more power) may be brought on-line and utilized for aggregated measurements or scoring. As such, the power management circuitry 150 (which may be controlled by the processor 70 or MCU 112) may be configured to make determinations regarding which sensors to selectively employ based on current power levels and/or current accuracy requirements or desires.

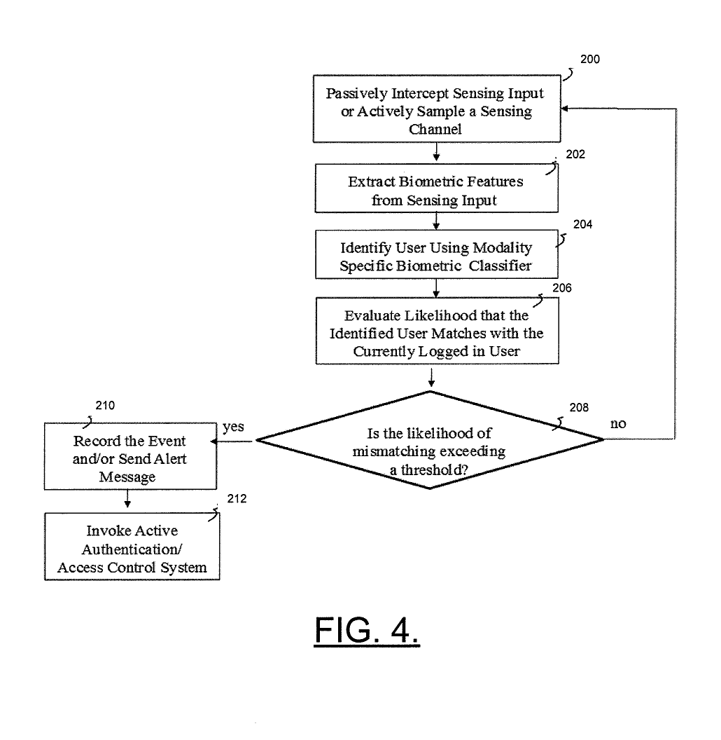

FIG. 4 illustrates a flow diagram showing a process of passive user identification according to an example embodiment. Unlike an active authentication/access control system, a passive user identification engine may passively intercept sensing inputs from at least one biometric sensor (e.g., touchscreen input, accelerometer inputs, location inputs, voice inputs, image inputs, ear sonar inputs and/or the like) at operation 200. Alternatively, a passive user identification engine can send requests to a sensor and retrieve sample data from the sensor. The actions can be performed in a way transparent to a user without disrupting the user's interaction with the computing system of the device being used (e.g., the mobile terminal 10). Biometric features may then be extracted from the sensing inputs at operation 202. The extracted features may be evaluated for identification of the user by a corresponding modality specific one of the multi-modality biometric classifiers at operation 204. Based on the features extracted, the likelihood that the current user matches a profile of the default or logged in user is determined (e.g., via the user identification engine 86) at operation 206. Thereafter a decision may be made as to whether the likelihood of mismatching (or alternatively, matching) exceeds a threshold at operation 208. The threshold may be set so that insignificant events can be treated as unknown in order to reduce the probability of receiving a false alarm. If the threshold for likelihood of mismatching is not exceeded, the process flow returns to operation 200 to continue evaluation over time. However, if the threshold for likelihood of mismatching is exceeded, the event may be recorded and/or an alert message may be sent at operation 210. In some cases, an active authentication of the user may be required at operation 212. Thus, for example, the user may be explicitly required to identify or authenticate himself or herself by entering a password, doing a fingerprint scan, answering certain security questions, etc.

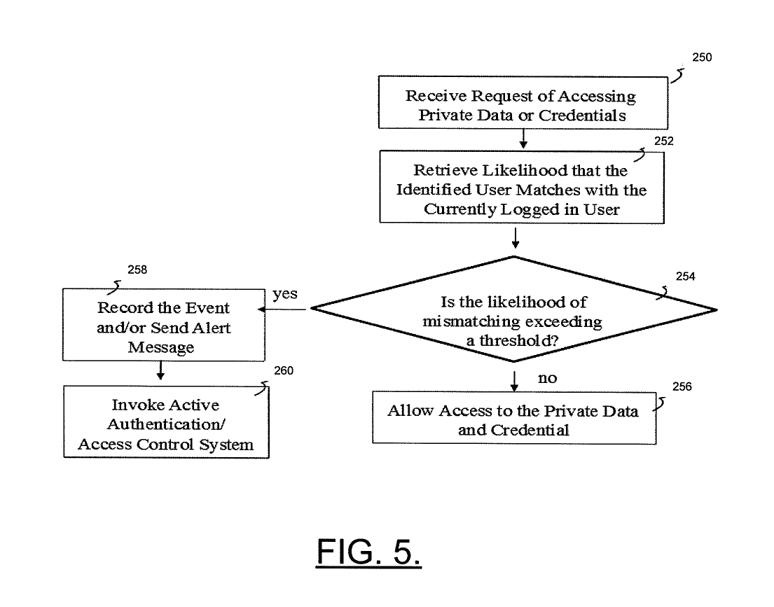

FIG. 5 illustrates a flow diagram showing a process of invoking active authentication when a current (or physical) user tries to access private or personal data or tries to access credentials that are stored in the mobile terminal 10 and are associated with the default profile or the current login profile. A credential may be a digital attestation of ownership or authority to access a service or resource provided by a local mobile computing system or remote networked service. A credential may be required to be supplied when a user tries to access a web service or tries to access a hardware/system resource. Private data may include any digital information that is private to a user (or an organization or entity) such as passwords, contact lists, financial data, calendar data, emails, instant messages, documents, etc.

As shown in FIG. 5, a request may be received for accessing private data or credentials at operation 250. In response to receipt of the request, information indicative of the likelihood that the current user (e.g., the identified user) matches the currently logged in user profile is retrieved at operation 252. A determination is then made at operation 254 as to whether the likelihood of mismatch exceeds a threshold. If the likelihood of mismatch does not exceed the threshold, access to the private data or credentials is enabled at operation 256. However, if the threshold for likelihood of mismatching is exceeded, the event may be recorded and/or an alert message may be sent at operation 258. In some cases, an active authentication of the user may be required at operation 260. As indicated above, for example, the user may be explicitly required to identify or authenticate himself or herself by entering a password, doing a fingerprint scan, answering certain security questions, etc.

Accordingly, some example embodiments of the present invention may provide ways to provide passive device security without presenting impediments to the user experience. Moreover, example embodiments may save power and be out of the reach of suspicious characters who may otherwise wish to disable example embodiments.

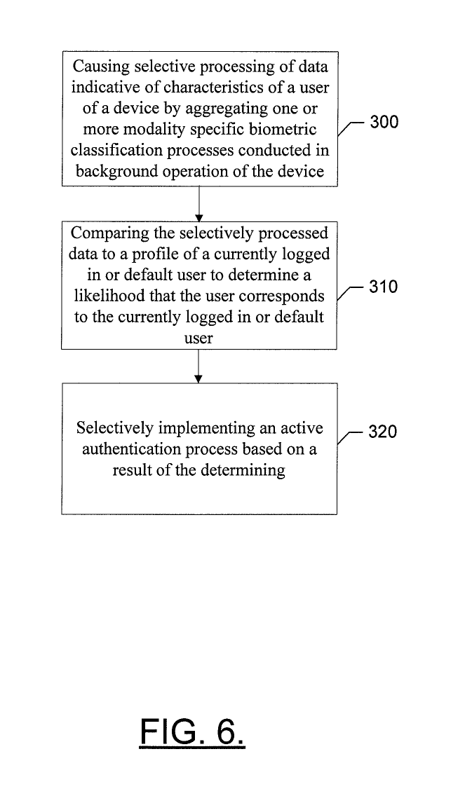

FIG. 6 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal (either mobile or fixed) and executed by a processor in the user terminal. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a non-transitory computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 6, may include causing selective processing of data indicative of characteristics of a user of a device by aggregating one or more modality specific biometric classification processes conducted in background operation of the device at operation 300, comparing the selectively processed data to a profile of a currently logged in or default user to determine a likelihood that the user corresponds to the currently logged in or default user at operation 310, and selectively implementing an active authentication process based on a result of the determining at operation 320.

In some embodiments, certain ones of the operations above may be modified or further amplified as described below. Moreover, in some embodiments additional optional operations may also be included. It should be appreciated that each of the modifications, optional additions or amplifications below may be included with the operations above either alone or in combination with any others among the features described herein. In some embodiments, causing selective processing may include considering both time and space properties with respect to aggregating the one or more modality specific biometric classification processes. In some embodiments, causing selective processing may include aggregating data from sensors selected from a plurality of biometric sensors based on available power at the device or utilizing a separate processor for aggregating the one or more modality specific biometric classification processes than a processor used for active foreground operations of the device. The separate processor may be utilized for the one or more modality specific biometric classification processes even while the device is in a sleep mode. In some embodiments, causing selective processing may include utilizing resources of a privileged domain for aggregating the one or more modality specific biometric classification processes or aggregating data from sensors selected from a plurality of biometric sensors based on selection of sensors to provide data based on both power consumption associated with each sensor and accuracy associated with each sensor. In an example embodiment, selectively implementing the active authentication process may include requiring manual user entry of authentication information in response to the likelihood of the user corresponding to the currently logged in or default user failing to reach a threshold or enabling continued operation of the device without user authentication in response to the likelihood of the user corresponding to the currently logged in or default user reaching the threshold.

In an example embodiment, an apparatus for performing the method of FIG. 6 above may comprise a processor (e.g., the processor 70 or MCU 112) configured to perform some or each of the operations (300-320) described above. The processor 70 and/or MCU 112 may, for example, be configured to perform the operations (300-320) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 300-320 may comprise, for example, the user identification engine 86. Additionally or alternatively, at least by virtue of the fact that the processor 70 may be configured to control or even be embodied as the user identification engine 86, the processor 70 and/or a device or circuitry for executing instructions or executing an algorithm for processing information as described above may also form example means for performing operations 300-320.

An example of an apparatus according to an example embodiment may include at least one processor and at least one memory including computer program code. The at least one memory and the computer program code may be configured to, with the at least one processor, cause the apparatus to perform the operations 300-320 (with or without the modifications and amplifications described above in any combination).

An example of a computer program product according to an example embodiment may include at least one computer-readable storage medium having computer-executable program code portions stored therein. The computer-executable program code portions may include program code instructions for performing operation 300-320 (with or without the modifications and amplifications described above in any combination).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
causing selective processing of data indicative of characteristics of a user of a device, the selective processing including aggregating one or more modality specific biometric classification processes conducted in background operation of the device;
comparing the selectively processed data to a profile of a currently logged in or default user to determine a likelihood that the user corresponds to the currently logged in or default user; and
selectively implementing an active authentication process based on a result of the determining.

2. The method of claim 1, wherein causing selective processing comprises considering both time and space properties with respect to aggregating the one or more modality specific biometric classification processes.

3. The method of claim 1, wherein causing selective processing comprises aggregating data from sensors selected from a plurality of biometric sensors based on available power at the device.

4. The method of claim 1, wherein causing selective processing comprises utilizing a separate processor for aggregating the one or more modality specific biometric classification processes than a processor used for active foreground operations of the device.

5. The method of claim 4, wherein utilizing the separate processor comprises utilizing the separate processor for the one or more modality specific biometric classification processes while the device is in a sleep mode.

6. The method of claim 1, wherein causing selective processing comprises utilizing resources of a privileged domain for aggregating the one or more modality specific biometric classification processes.

7. The method of claim 1, wherein causing selective processing comprises aggregating data from sensors selected from a plurality of biometric sensors based on selection of sensors to provide data based on both power consumption associated with each sensor and accuracy associated with each sensor.

8. The method of claim 1, wherein selectively implementing the active authentication process comprises requiring manual user entry of authentication information in response to the likelihood of the user corresponding to the currently logged in or default user failing to reach a threshold or enabling continued operation of the device without user authentication in response to the likelihood of the user corresponding to the currently logged in or default user reaching the threshold.

9. An apparatus comprising at least one processor and at least one memory including computer program code, the at least one memory and the computer program code configured to, with the processor, cause the apparatus to at least:
cause selective processing of data indicative of characteristics of a user of a device, the selective processing including aggregating one or more modality specific biometric classification processes conducted in background operation of the device;
compare the selectively processed data to a profile of a currently logged in or default user to determine a likelihood that the user corresponds to the currently logged in or default user; and
selectively implement an active authentication process based on a result of the determining.

10. The apparatus of claim 9, wherein the at least one memory and the computer program code are further configured, with the processor, to cause selective processing by considering both time and space properties with respect to aggregating the one or more modality specific biometric classification processes.

11. The apparatus of claim 9, wherein the at least one memory and the computer program code are further configured, with the processor, to cause selective processing by aggregating data from sensors selected from a plurality of biometric sensors based on available power at the device.

12. The apparatus of claim 9, wherein the at least one memory and the computer program code are further configured, with the processor, to cause selective processing by utilizing a separate processor for aggregating the one or more modality specific biometric classification processes than a processor used for active foreground operations of the device.

13. The apparatus of claim 12, wherein the at least one memory and the computer program code are further configured, with the processor, to cause selective processing by utilizing the separate processor for the one or more modality specific biometric classification processes while the device is in a sleep mode.

14. The apparatus of claim 9, wherein the at least one memory and the computer program code are further configured, with the processor, to cause selective processing by utilizing resources of a privileged domain for aggregating the one or more modality specific biometric classification processes.

15. The apparatus of claim 9, wherein the at least one memory and the computer program code are further configured, with the processor, to cause selective processing by aggregating data from sensors selected from a plurality of biometric sensors based on selection of sensors to provide data based on both power consumption associated with each sensor and accuracy associated with each sensor.

16. The apparatus of claim 9, wherein the at least one memory and the computer program code are further configured, with the processor, to selectively implement the active authentication process by requiring manual user entry of authentication information in response to the likelihood of the user corresponding to the currently logged in or default user failing to reach a threshold or enabling continued operation of the device without user authentication in response to the likelihood of the user corresponding to the currently logged in or default user reaching the threshold.

17. A computer program product comprising at least one non-transitory computer-readable storage medium having computer-executable program code instructions stored therein, the computer-executable program code instructions comprising program code instructions to:
cause selective processing of data indicative of characteristics of a user of a device, the selective processing including aggregating one or more modality specific biometric classification processes conducted in background operation of the device; compare the selectively processed data to a profile of a currently logged in or default user to determine a likelihood that the user corresponds to the currently logged in or default user; and
selectively implement an active authentication process based on a result of the determining.

18. The computer program product of claim 17, wherein program code instructions for causing selective processing include instructions for utilizing a separate processor for aggregating the one or more modality specific biometric classification processes than a processor used for active foreground operations of the device.

19. The computer program product of claim 17, wherein program code instructions for causing selective processing include instructions for utilizing resources of a privileged domain for aggregating the one or more modality specific biometric classification processes.

20. The computer program product of claim 17, wherein program code instructions for causing selective processing include instructions for aggregating data from sensors selected from a plurality of biometric sensors based on selection of sensors to provide data based on both power consumption associated with each sensor and accuracy associated with each sensor.
